(19) United States
(12) Patent Application Publication
(10) Pub. No.: US 2006/0011580 A1
(43) Pub. Date: Jan. 19, 2006

(54) Plasma processing method and post-processing method

(75) Inventor: Akitaka Shimizu, Nirasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 11/159,228

(22) Filed: Jun. 23, 2005

Related U.S. Application Data
(60) Provisional application No. 60/589,790, filed on Jul. 22, 2004.

(30) Foreign Application Priority Data
Jun. 23, 2004 (JP) 2004-184489

(51) Int. Cl. B44C 1/22; C23F 1/00; C25F 5/00

(52) U.S. Cl. 216/67; 216/57; 134/1.3

(57) ABSTRACT

A plasma processing method and a post-processing method can certainly prevent corrosion not only in a processing chamber but also in a transfer system. The plasma processing method for performing a plasma process on an object to be processed in a chamber includes a first plasma process for processing the object to be processed by a first plasma that is generated by plasmarizing a gas containing at least a halogen element; a second plasma process for processing the chamber and the object to be processed by supplying an oxygen-containing gas in the chamber to generate a second plasma after the first plasma process; and a third plasma process for processing the object to be processed after the second plasma process by using a third plasma that is generated by plasmarizing a gas containing at least nitrogen and hydrogen.

### CROSS-REFERENCE TO RELATED APPLICATIONS

This document claims priority to Japanese Patent Application Number 2004-184489, filed Jun. 23, 2004 and U.S. Provisional Application No. 60/589,790, filed Jul. 22, 2004, the entire content of which are hereby incorporated by reference.

### FIELD OF THE INVENTION

The present invention relates to a plasma processing method and a post-processing method; and, more particularly to a plasma processing method and a post-processing method for performing an etching process on a semiconductor wafer or the like.

### BACKGROUND OF THE INVENTION

In the process of dry-etching a substrate such as a semiconductor wafer by using corrosive gas such as hydrogen bromide or chlorine, there has been a need to come up with a method to prevent the particle generation from the desquamation of a reaction product attached inside a process chamber as well as the deterioration due to the corrosive gas in the chamber. For this reason, it has been proposed to perform cleaning by using O₂ plasma after the dry-etching (For example, Japanese Patent Laid-open Application No. S63-5532, Claims). The cleaning by using O₂ plasma is effective in replacing the halogen atmosphere of the chamber, the prevention of corrosion inside the chamber and the elimination of the corrosive gas adsorbed on a substrate by sputtering method.

However, the deposits of reaction products are observed on the substrate after the etching process. For instance, when a silicon substrate is etched, the reaction products such as SiBr₄, SiCl₄ are deposited thereon. It is difficult to completely remove the deposits by a post-process using O₂ plasma.

As mentioned above, it is difficult to completely eliminate the deposits on the substrate by the O₂ gas plasma cleaning. When the deposits on the substrate are left in an open atmosphere, a corrosive gas such as a halogen gas tends to be generated. Therefore, in a subsequent process, a corrosive gas is generated from the deposits on the substrate in a transfer system, thereby corroding the transfer system. In general, since the inner surface of the chamber for performing, e.g., an etching process by using a corrosive gas is made of aluminum or alumite, it can stand well against corrosion basically. However, since transfer systems are not expected to have a direct contact with any corrosive gas, any deterioration due to the corrosion will have a serious adverse effect on the durability of the entire system, resulting in a significant deterioration thereof. Up to this point, however, practically no countermeasures against this corrosion in the transfer system have been discussed in the literature.

### SUMMARY OF THE INVENTION

It is, therefore, an object of the present invention to provide a plasma processing method and a post-processing method capable of certainly preventing the corrosion not only in a processing chamber but also in a transfer system.

To achieve the objects, in accordance with a first aspect of the present invention, there is provided a plasma processing method for performing a plasma process on an object to be processed in a chamber, including: a first plasma process for processing the object to be processed by a first plasma that is generated by plasmarizing a gas containing at least halogen element; a second plasma process for processing the chamber and the object to be processed by supplying an oxygen-containing gas in the chamber to generate a second plasma after the first plasma process; and a third plasma process for processing the object to be processed after the second plasma process by using a third plasma that is generated by plasmarizing a gas containing at least nitrogen and hydrogen.

In the plasma processing method, by performing the second and third processing method, it is possible to prevent the corrosion caused by halogen, not only in the process chamber but also in the transfer system.

In the above mentioned plasma processing method, the first to the third plasma process can be performed in the same chamber. In this case, it is possible to realize the cleaning of the chamber and the quality modification of deposits on the surface of the to-be-processed object in all-in-one process.

Further, the first and the second plasma process can be performed in the same chamber while the third plasma process can be performed in a separate chamber. In this case, by transferring the object to be processed into the separate chamber, it is possible to nearly completely eliminate the effect of the halogen atmosphere on the chamber where the first plasma process was performed. Therefore, the generation of the corrosive gas can be certainly prevented in the transfer system.

Further, in the plasma processing method, it is preferable that the halogen element is chlorine or brome, and the gas containing at least nitrogen and hydrogen is an ammonia gas or a mixed gas of nitrogen and hydrogen gas. In this case, silicon halide that is attached to the to-be-processed object is changed into ammonium halide and becomes stable in the third plasma process. Therefore, it is possible to prevent the production of halogen in the transfer system.

Further, it is preferable that the above mentioned plasma processing method includes a cleaning process of wet-cleaning the to-be-processed object after the third plasma process. In this case, it is easy to clean and remove ammonium halide.

In a preferable example of the plasma processing method, the first plasma process is a plasma etching process on a silicon substrate. In this case, the etching process is effectively realized by a corrosive gas, and the corrosion of both the chamber and the transfer system is prevented at the same time.

In accordance with a second aspect of the present invention, there is provided a post-processing method, performed after the process using a corrosive gas, on an object to be processed in a chamber including O₂ plasma process for processing the chamber and the object to be processed by supplying an oxygen-containing gas to the chamber to generate O₂ plasma; and NH₃ plasma process for processing the object to be processed after the O₂ plasma process by NH₃ plasma generated by plasmarizing a gas containing at least nitrogen and hydrogen.

In the above post-processing method, the process using a corrosive gas, the O₂ plasma process and the NH₃ plasma process can be performed in the same chamber. In this case, it is possible to realize the cleaning of the chamber and the quality modification of the deposits on the surface of the to-be-processed object in all-in-one process that is performed in a single chamber.

On the other hand, the O₂ plasma process and the NH₃ plasma process can be performed in different chambers respectively. In this case, by transferring the to-be-processed object into a separate chamber, it is possible to nearly completely eliminate the effect from the corrosive gas. Therefore, the quality modification efficiency of the deposits on the surface of the to-be-processed object is enhanced, which in turn can prevent the carry over of the corrosive gas into the transfer system certainly.

In the post-processing method, when the corrosive gas includes at least a halogen element and the gas containing at least nitrogen and hydrogen is an ammonia gas or a mixed gas of nitrogen and hydrogen gas, silicon halide attached to the to-be-processed object is changed into ammonium halide in the NH₃ plasma process and becomes stable. Therefore, it is possible to prevent the production of halogen in the transfer system.

It is preferable that the post-processing method includes a cleaning process for wet-cleaning the to-be-processed object after the NH₃ plasma process. In this case, it is possible to easily clean and remove the ammonium halide.

In the preferable example of the post-processing method, the process using a corrosive gas is an etching process on a silicon substrate. In this case, the etching process is effectively realized by the corrosive gas, and the corrosion of both the chamber and the transfer system is prevented at the same time.

### BRIEF DESCRIPTION OF THE DRAWINGS

The above and other objects and features of the present invention will become apparent from the following description of preferred embodiments given in conjunction with the accompanying drawings, in which:

FIG. 1 is a schematic view for illustrating a surface state of the wafer after a first plasma processing;

FIG. 2 is a schematic view for illustrating a surface state of the wafer after a second plasma processing;

FIG. 3 is a schematic view for illustrating a surface state of the wafer after a third plasma processing;

FIG. 4 is a schematic view showing a configuration of a plasma processing apparatus appropriate for an inventive method;

FIG. 5 is a view showing a configuration of a processing unit in cross section; and

FIG. 6 is a schematic view showing a configuration of another plasma processing apparatus appropriate for an inventive method.

### DETAILED DESCRIPTION OF PREFERRED EMBODIMENTS

In the present invention, a substrate such as a semiconductor wafer is exemplified as an object to be processed.

In a plasma processing method in accordance with the present invention, the term “gas containing at least halogen elements” is used to represent gas containing halogen elements such as chlorine or brome as configuration elements, and as an example thereof, hydrogen bromide, hydrogen chlorine, and chlorine gas or the like may be given. Therefore, a plasma etching process using a halogen gas can be exemplified as a first plasma process.

Also, O₂, or a mixture of O₂ and an inert gas such as a rare gas can be employed as “oxygen-containing gas”. Therefore, an O₂ plasma process using an O₂ plasma gas can be exemplified as a second plasma process. The second plasma process removes the halogen gas elements (Cl₂, HBr etc) that are physically adsorbed in the object to be processed in the first plasma process, changes the chamber atmosphere such that the O₂ gas replaces the halogen gas remaining in the chamber, and eliminates the deposits such as SiCl₄, SlBr₄ attached at a wall surface of the chamber.

In the plasma processing method in accordance with the present invention, an NH₃ gas or a mixed gas of N₂ and H₂ or the like can be employed as “the gas containing at least nitrogen and hydrogen”. Therefore, an NH₃ plasma process using an NH₃ plasma can be employed as a third plasma process as an example.

In the third plasma process, silicon halide such as SiCl₄, SiBr₄ (SiX₄; Here X is the halogen element. It is the same hereinafter) that is deposited on the object to be processed such as a semiconductor wafer during the first plasma process, or Cl₂, HBr and the like that is physically adsorbed to the object to be processed is changed into ammonium halide such as NH₄Cl, NH₄Br (NH₄X; Here X is identical as above. It is the same hereinafter). Since ammonium halide does not volatilize in an open atmosphere, the generation of a halogen gas is suppressed in the transfer system, and therefore the corrosion thereof can be prevented in advance.

Since the ammonium halide that is generated in the third plasma process is a water-soluble material, it can be easily removed by wet cleaning process. The condition for the wet cleaning process is identical to that for an ordinary wet cleaning process.

In the method of the present invention, it is possible to process the first, the second and the third process in the same chamber. In this case, the second plasma process performs the replacement of the halogen atmosphere inside the chamber created by the first plasma process, and removes the deposits in the chamber and the halogen gas molecule adsorbed to the object to be processed. And, the quality modification of the deposits (transformed into ammonium halide) becomes possible by the third plasma process.

Also, the first and the second plasma process can be performed in the same chamber while the third plasma process can be performed in a separate chamber by loading the object to be processed thereinto. In this case, the halogen atmosphere produced in an initial chamber in the first plasma process is substituted, and the deposits in the initial chamber and the halogen gas molecule adsorbed to the to-be-processed object are removed in the second plasma process. Also, in the third plasma process that is performed in the separate chamber, only the quality modification of the reaction products deposited on the surface of the object to be processed is performed. In this case, the object to be processed is preferably transferred between the chambers under a vacuum condition.

The condition for the plasma process is not specifically limited, but for example the first plasma process can be performed for 50 seconds, and as a post-processing, the second and the third plasma process are respectively conducted for 5 seconds.

Also, in addition to the first to the third plasma process, another different process can be included if necessary. For example, if the first plasma process is the etching process of the silicon wafer, it is desirable to add a process for removing the natural oxide film in the surface of the silicon wafer as a pre-process.

The post-processing method in accordance with the present invention is the one that is performed after executing a process by using a corrosive gas. The post-processing method is conducted by performing the O₂ plasma process (cleaning process) and the NH₃ plasma process (quality modification process) on the chamber and/or the to-be-processed object after conducting the process using a corrosive gas, wherein the O₂ plasma process (cleaning process) is performed by using an O₂ plasma generated by plasmarizing the oxygen-containing gas and the NH₃ plasma process (quality modification process) is performed by processing the object to be processed by using an NH₃ plasma generated by plasmarising the gas containing at least nitrogen and hydrogen. Here, as an example of the process using a corrosive gas, a plasma etching process using a halogen-containing gas may be given, for example, the first plasma processing method of the above mentioned plasma processing method. Also, the O₂ plasma process can be performed as in the case of the second plasma process of the above mentioned plasma processing method, and the NH₃ plasma process can be performed as in the case of the third plasma process.

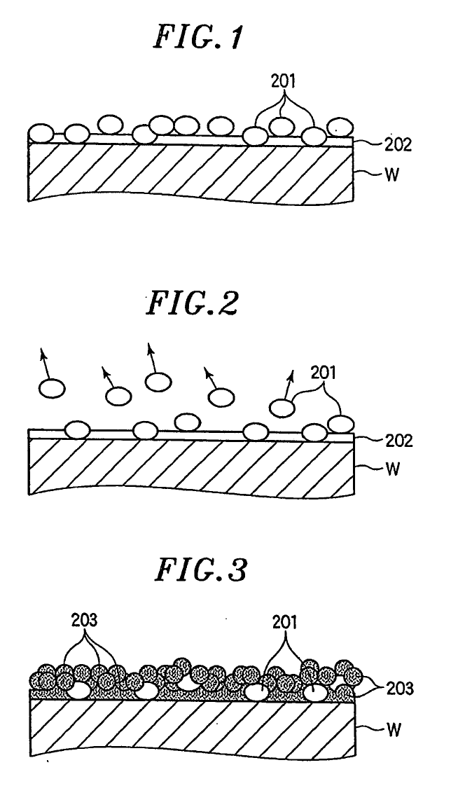

Next, the operation of the present invention will now be described with reference to FIGS. 1 to 3. FIGS. 1 to 3 are schematic views setting forth the principle of the plasma processing method in accordance with the present invention. FIG. 1 shows the cross sectional view around the surface of the semiconductor wafer (hereinafter referred to as “wafer”) W after the wafer W, that is to be the object to be processed, has been subjected to the first plasma process by using a corrosive gas. By the first plasma process, a alogen-based adsorbent 201 such as Cl₂ or HBr is physically adsorbed on the surface of the wafer W, and also deposits 202 including SiX₄ (X is halogen element such as chlorine or brome) and the like is adhered thereto.

When the second plasma process is performed after the first plasma process, the adsorbent 201 is removed by an O₂ plasma sputtering method. As a result, the adsorbent 201 is mostly but not completely removed, whereas the deposits 202 are nearly completely preserved on the wafer W as shown in FIG. 2. Also, in the inner wall of the chamber used in the first plasma process, since the adsorbent 201 is removed by the same mechanism as shown in FIG. 2 and at the same time the atmosphere inside the chamber is substituted, the inner wall of the chamber is prevented from being corroded.

Next, when the third plasma process is performed on the wafer W, SiX₄ in the deposits 202 changes into ammonium halide (NH₄X) and transforms into a quality modification material 203 by the operation of the NH₃ plasma as shown in FIG. 3. Also, the remaining halogen-based adsorbent 201 is fixed on the surface of the wafer W by the quality modification material 203. Since the quality modification material 203 does not produce any halogen gas even if it is exposed to an open atmosphere in the transfer system such as inside FOUP, the transfer system can be prevented from being corroded. Also, since NH₄X produced in the third plasma process is water-soluble, it can be easily removed by a wet cleaning.

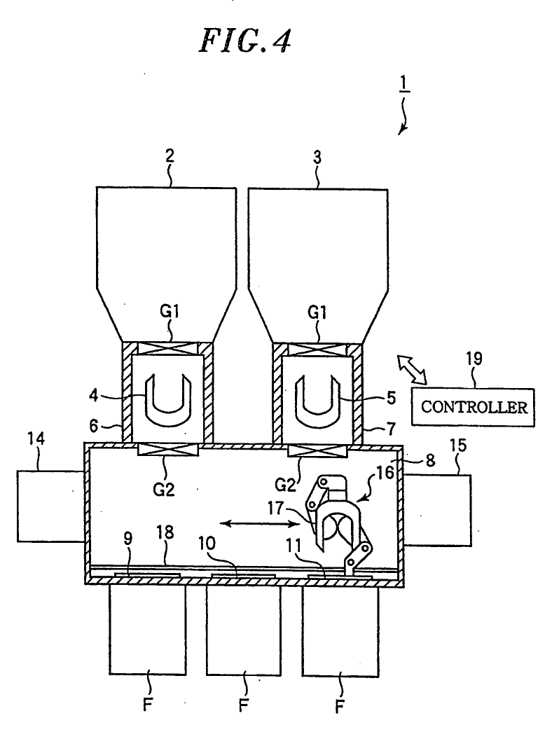

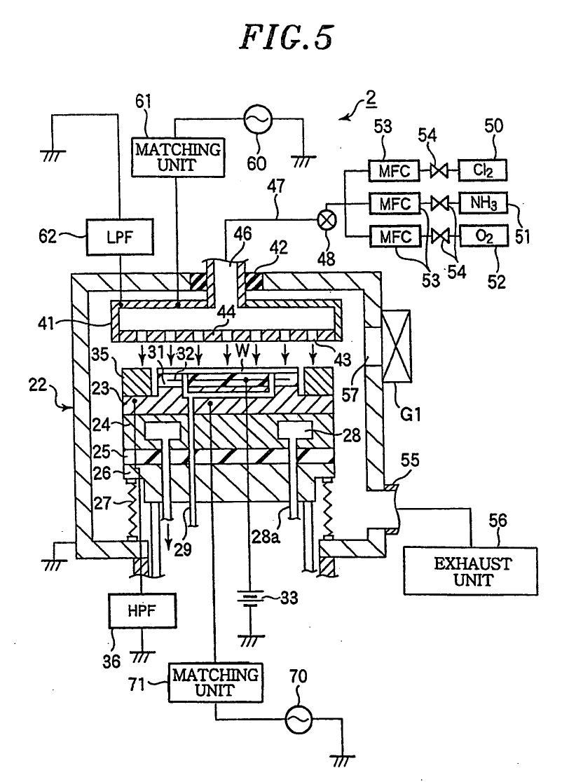

Next, the preferred embodiment in accordance with the present invention will now be described with reference to the drawing showing the specific configuration of the plasma processing apparatus. FIG. 4 is a horizontal cross sectional view that schematically shows the plasma processing apparatus appropriate for the inventive method. The plasma processing apparatus performs the etching process and the post-process on the wafer W as the object to be processed, under a predetermined vacuum condition.

The plasma processing apparatus 1 includes two processing units 2 and 3 and each of the processing units 2 and 3 is independently configured to carry out all-in-one process of performing an etching process on the wafer W as well as the post-process. The processing units 2 and 3 are respectively connected to load-lock chambers 6 and 7 via gate valves G1. On the sides of the load-lock chambers 6 and 7 opposite to the sides to which the processing units 2 and 3 are respectively connected, there is provided a wafer loading/unloading chamber 8, and on the side of the wafer loading/unloading chamber 8 opposite to the side where the load-lock chambers 6 and 7 are installed, there are provided three connection ports 9, 10 and 11 for connecting FOUPs F capable of holding wafers thereto.

The two processing units 2 and 3 communicate with the load-lock chambers 6 and 7 independently by opening the respective gate valves G1, and are independently isolated from the load-lock chambers 6 and 7 by closing them. Also, there are other gate valves G2 at the portions of the load-lock chambers 6 and 7 that are independently connected to the loading/unloading chamber 8, and the load-lock chambers 6 and 7 communicate with the loading/unloading chamber 8 independently by opening respective gate valves G2, and are independently isolated from the loading/unloading chamber 8 by closing them.

In the load-lock chambers 6 and 7, there are respectively provided wafer transfer devices 4 and 5 for loading/unloading the wafer W as the object to be processed, between corresponding one of the processing units 2, 3 and the wafer loading/unloading chamber 8.

On the ceiling portion of the wafer loading/unloading chamber 8, there is provided a HEPA filter (not shown), and the clean air flows into the wafer loading/unloading chamber 8 downward through the HEPA filter such that the wafer loading/unloading operation can be performed in a clean air atmosphere under an atmospheric pressure. Shutters (not shown) are respectively installed at three connection ports 9, 10 and 11, wherein the three connection ports 9, 10 and 11 are provided in the wafer loading/unloading chamber 8 for directly fixing thereat respective FOUPs F, each holding a wafer or being empty. When a FOUP F is installed, the corresponding shutter is opened so that the FOUP can communicate with the wafer loading/unloading chamber 8 while preventing the exterior air from flowing thereinto. Also, the wafer loading/unloading chamber 8 is provided with an alignment chamber 14 at one lateral side, and the wafers W are aligned therein. The wafer loading/unloading chamber 8 is provided with a cleaning chamber 15 at the other lateral side, and the wafer wet cleaning after the plasma processing is processed therein.

In the wafer loading/unloading chamber 8, there is installed a wafer transfer device 16 for loading/unloading the wafer W into/from the FOUPs F and the load-lock chambers 6 and 7. The wafer transfer device 16 has a multi-joint arm structure, and can run along the rail 18 that is lying in a left direction parallel to the FOUPs F array, and transfers the wafer W after placing the wafer W on a pick 17 installed at an end thereof. The entire system control such as the operation of the wafer transfer system 16 is done by the controller 19.

In this kind of plasma processing apparatus 1, first of all, a wafer W is unloaded from a specified FOUP F and is loaded into the alignment chamber 14 by the wafer transfer device 16 in the wafer loading/unloading chamber 8 that maintains a clean air in the atmospheric pressure, and then the position alignment is performed on the wafer W. Next, the wafer W is loaded into one of the load-lock chambers 6 and 7, and then the load-lock chamber is evacuated. Thereafter, the wafer W in the load-lock chamber is loaded into the processing unit 2 or 3 by the wafer transfer device 4 or 5 for etching, and the etching process and the post-process are successively performed thereon in the same processing unit. Subsequently, the wafer W is loaded into the load-lock chamber 6 or 7 by the wafer transfer device 4 or 5 and the load-lock chamber is returned into the atmospheric pressure. After that, the wafer W is unloaded therefrom and inserted into the wet cleaning chamber 15 by the wafer transfer device 16 in the wafer loading/unloading chamber 8 to undergo the wet cleaning. In the cleaning chamber 15 the quality modification film NH₄X is removed by wet-cleaning the wafer W with washing fluid such as water. Thus cleaned wafer W is also accommodated into one of the FOUPs F by the wafer transfer device 16. This operation is performed on 1 lot of wafers W, and thus the process for 1 lot is terminated.

The description of the processing unit 2 will now be described in detail with reference to FIG. 5. FIG. 5 is a schematic cross sectional view of the processing unit 2. As previously mentioned above, the processing unit 2 is configured such that the O₂ plasma process as “second plasma process” of “post-processing” and the NH₃ plasma process as “third plasma process” can be performed in the same chamber after the dry etching is performed as the “first plasma process”.

Also, the processing unit 2 is included in a capacitively coupled parallel plate type etching apparatus wherein electrode plates face each other in parallel and a power supply is connected to one of the electrode plates.

This processing unit 2 includes a, e.g., cylindrical processing vessel 22 made of aluminum and having a surface on which the ceramic thermal spray treatment is performed, and the chamber 22 is frame grounded. In the above chamber 22, a susceptor 23 functioning as a lower electrode is supported by a supporting member 24, wherein the wafer W made of, e.g., silicon on which prescribed films are formed is mounted on the susceptor 23. The supporting member 24 is supported by a support 26 of an elevation mechanism (not shown) via an insulating plate 25 made of, e.g., ceramic, and the susceptor 23 can be vertically moved by the elevation mechanism. An atmospheric central region of a lower part of the support 26 is covered with a bellow 27, and therefore the atmospheric region is separated from the interior of the chamber 22.

Provided within the supporting member 24 is a coolant room 28 through which a coolant such as Galden introduced through a coolant introducing line 28a is circulated to generate a cold heat. The generated cold heat is thermally conducted to the wafer W via the susceptor 23, such that the temperature of a process surface of the wafer W can be adjusted to a desired temperature. Also, even though the chamber 22 is maintained under a vacuum state, in order for the coolant circulating in the coolant room 28 to effectively cool the wafer W, a gas passage 29 for supplying a heat conduction medium such as a He gas is formed in the back surface of the wafer W to be processed. As a result, the cold heat in the susceptor 23 is transferred to the wafer W effectively through the heat conduction medium, thereby precisely controlling the temperature of the wafer W.

The susceptor 23 has at its central topmost portion a convex disk shape and an electrostatic chuck 31 is provided thereon, wherein the electrostatic chuck 31 has an electrode 32 embedded in an insulting material and electrostatically adsorbs the wafer W by e.g., a Coulomb force by DC voltage applied from a DC power supply 33 connected to the electrode 32. Around an upper part of the susceptor 23, there is installed an annular focus ring 35 for enhancing the etching uniformity, wherein the annular focus ring 35 surrounds the wafer W located on top of the electrostatic chuck 31.

Above the susceptor 23, there is provided a shower head 41 functioning as an upper electrode and facing the susceptor 23 in parallel. The shower head 41 is supported at the upper part of the chamber 22 via an insulating member 42, and has a plurality of injection openings 43 in a surface 44 facing the susceptor 23. Also, the shower head 41 is spaced apart from the wafer W by, e.g., a distance of 30-90 mm and the distance can be controlled by the elevation mechanism.

The shower head 41 is provided at its central portion with a gas inlet port 46 to which a gas supply line 47 is connected. Further, the gas supply line 47 is connected to a gas supply system for supplying an etching gas and a cleaning gas via a valve 48. The gas supply system includes a Cl₂ gas supply source 50, an NH₃ gas supply source 51, and an O₂ gas supply source 52, and in lines from these gas supply sources, there are respectively provided with mass flow controllers 53 and valves 54.

Also, a Cl₂ gas as an etching gas, and an NH₃ gas and an O₂ gas as a post-processing gas are independently introduced into an interior space of the shower head 41 from the respective gas supply sources via the gas supply line 47 and the gas inlet opening 46, and then are discharged through the gas injection openings 43.

In the vicinity of the bottom of the side wall of the chamber 22 there is provided an exhaust port 55 to which an exhaust unit 56 is connected. The exhaust unit 56 is equipped with a vacuum pump such as a turbo molecular pump and accordingly, it can be configured so that the chamber 22 is evacuated to the predetermined depressurized atmosphere, e.g., a predetermined pressure below 1 Pa. Also, there is provided in the side wall of the chamber 22 a loading/unloading port 57 and a gate valve G1 for opening/closing the loading/unloading port 57. While the gate valve G1 is closed, the wafer W is loaded into and unloaded from the adjacent load-lock chamber 6 (see FIG. 4).

The shower head 41 functioning as the upper electrode is connected to a high frequency power supply 60 and its feeder line is provided with a matching unit 61. The high frequency power supply 60 supplies the shower head 41 functioning as the upper electrode with a high frequency power, e.g. 60 MHz, thereby forming a high frequency electric field for generating a plasma between the shower head 41 of the upper electrode and the susceptor 23 of the lower electrode. Also, a low pass filter (LPF) 62 is connected to the shower head 41.

The susceptor 23 functioning as the lower electrode is connected to a high frequency power supply 70 and its feeder line is provided with the matching unit 71. The high frequency power supply 70 supplies the susceptor 23 functioning as the lower electrode with a high frequency power, e.g. 13.56 MHz to thereby make the ions in the plasma be attracted toward the wafer W such that an etching of a high anisotropy can be performed thereon. Also, a high pass filter (HPF) 36 is connected to the susceptor 23.

When the etching process is carried out by using the apparatus shown in FIG. 5, first of all, the gate valve G1 is opened and a wafer W is loaded into the chamber 22 to be mounted on the susceptor 23. Next, the gate valve G1 is closed and the susceptor 23 is elevated so that a distance between the surface of the wafer W on the susceptor 23 and the shower head 41 is adjusted to become about 30-90 mm. Thereafter, the chamber 22 is depressurized by evacuating the chamber 22 through the exhaust port 55 by means of the vacuum pump of the exhaust unit 56 and then DC voltage from the DC power source 33 is applied onto the electrode 32 in the electrostatic chuck 31.

Following this, the Cl₂ gas is introduced into the chamber 22 from the Cl₂ gas supply source 50 as the etching gas. Further, the high frequency power, e.g. 60 MHz is applied on the shower head 41 from the high frequency source 60 which in turn generates a high frequency electric field between the shower head 41 functioning as the upper electrode and the susceptor 23 functioning as the lower electrode, thereby plasmarizing the Cl₂ gas. As the plasma is generated, the wafer W is electrostatically adsorbed on the electrostatic chuck 31.

The wafer W is etched by the thus generated plasma of the etching gas. At this time, a predetermined high frequency power is applied to the susceptor 23 functioning as the lower electrode from the high frequency power supply 70 such that the ions in the plasma can be attracted toward the susceptor 23.

In the processing unit 2, if a cleaning process using the O₂ gas or a quality modification process using the NH₃ gas is performed as the post-process, the same plasma processes are performed respectively by using the O₂ and the NH₃ gas instead of using Cl₂ as the etching gas.

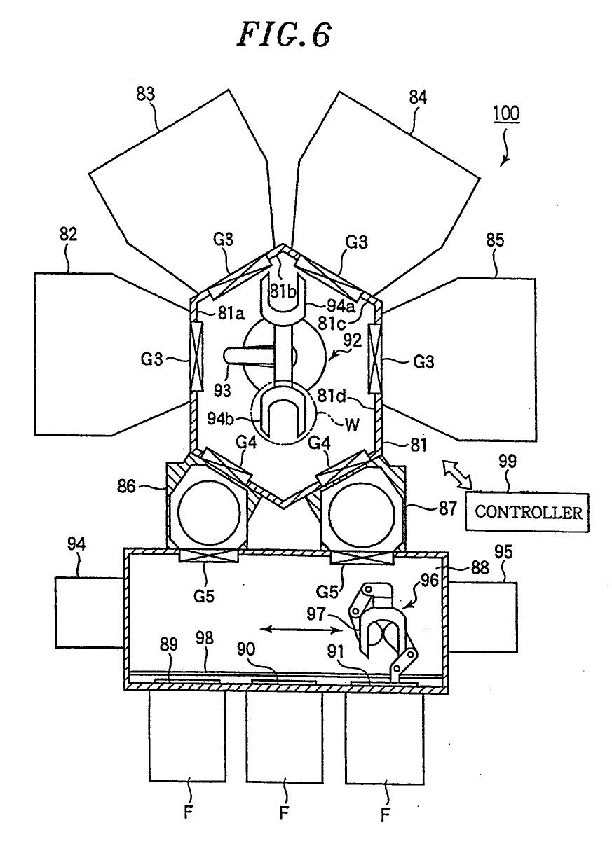

FIG. 6 shows a schematic structure of a multi chamber type plasma processing apparatus 100. As shown in FIG. 6, the plasma processing apparatus 100 includes etching processing units 82 and 83, wherein each of them performs an etching process and an O₂ plasma process on the wafer W, and NH₃ plasma processing units 84 and 85, wherein each of them performs an ammonia plasma process. Further, the plasma processing unit 100 includes a wafer transfer chamber 81 of a hexagonal shape whose four sides are respectively provided with connection ports 81a, 81b, 81c and 81d for respectively connecting predetermined processing units thereto. The etching processing unit 82 is connected to the connection port 81a, and an etching processing unit 83 is connected to the connection port 81b, the NH₃ plasma processing unit 84 is connected to the connection port 81c, and the NH₃ plasma processing unit 85 is connected to the connection port 81d.

Also, in the other two sides of the wafer transfer chamber 81, there are respectively provided with load-lock chambers 86 and 87. On the opposite sides of the load-lock chambers 86 and 87 with respect to the wafer transfer chamber 81, there is provided a wafer loading/unloading chamber 88, and on the opposite side of the wafer loading/unloading chamber 88 with respect to the load-lock chambers 86 and 87, there are installed three connection ports 89, 90 and 91 to which FOUPs F capable of holding wafer W are respectively connected.

Each of the etching processing units 82 and 83, the NH₃ plasma processing units 84 and 85 and the load-lock chambers 86 and 87 are connected to each other via the wafer transfer chamber 81, wherein each of them communicates with the wafer transfer chamber 81 by opening either the gate G3 or G4 and is isolated therefrom by closing either the gate valve G3 or G4. Also, gate valves G5 are installed at the parts where the load-lock chambers 86 and 87 are connected to the wafer loading/unloading chamber 88, wherein the load-lock chambers 86 and 87 communicate with the wafer loading/unloading chamber 88 by opening the respective gate valves G5 and are isolated therefrom by closing the respective gate valves G5.

Installed within the wafer transfer chamber 81 is a wafer transfer device 92 for loading/unloading a wafer W as the to-be-processed object from/into the etching processing units 82, 83, the NH₃ plasma processing units 84, 85 and the load-lock chambers 86, 87. The wafer transfer device 92 is located at an approximately central portion of the wafer transfer chamber 81 and has two blades 94a, 94b for keeping the wafer W on an end of a rotatable and expansible/contractible part 93, wherein two blades 94a and 94b are installed at the rotatable and expansible/contractible part 93 to face toward opposite direction from each other. Also, the interior of the wafer transfer chamber 81 is maintained at a prescribed vacuum level.

On the ceiling portion of the wafer loading/unloading chamber 88, there is provided a HEPA filter (not shown), and the clean air flows into the wafer loading/unloading chamber 88 downward through the HEPA filter such that the wafer loading/unloading operation is performed in a clean air atmosphere under the atmospheric pressure. Shutters (not shown) are respectively installed at three connection ports 89, 90 and 91, provided in the wafer loading/unloading chamber 88, for fixing thereat respective FOUPs F, and at the connection ports 89, 90 and 91 there are directly installed respective FOUPs F, each holding a wafer W or being empty. When FOUPs F are installed, the shutters open for FOUPs F to be in communication with the wafer loading/unloading chamber 88 while preventing the exterior air from flowing thereinto. Also, the wafer loading/unloading chamber 88 is provided with an alignment chamber 94 at one lateral side, and the wafers W are aligned therein. The wafer loading/unloading chamber 88 is provided with a cleaning chamber 95 at the other lateral side, and the wafer wet cleaning after the plasma processing is performed therein.

In the wafer loading/unloading chamber 88, there is installed a wafer transfer device 96 for loading/unloading the wafer W into/from the FOUPs F and the load-lock chambers 86 and 87. The wafer transfer device 96 has a multi-joint arm structure, and can run along the rail 98 that is lying in a left direction parallel to the FOUPs F array, and transfers the wafer W after placing the wafer W on a pick 97 installed at its end. The entire system control such as operations of the wafer transfer devices 92, 96 is done by the controller 99.

In this kind of plasma processing apparatus 100, first of all, a wafer W is unloaded from one of the FOUPs F and is loaded into the alignment chamber 94 by the wafer transfer device 96 provided in the wafer loading/unloading chamber 88 that maintains a clean air atmosphere under the atmospheric pressure, and then the position alignment of the wafer W is performed. Next, the wafer W is loaded into one of the load-lock chambers 86 and 87, and then the load-lock chamber is evacuated. Subsequently, the wafer W in the load-lock chamber is taken out by the wafer transfer device 92 in the wafer transfer chamber 81.

Thereafter, the wafer W is loaded into the etching processing unit 82 or 83, and an etching process and an O₂ plasma process are successively performed on the wafer W. Then the wafer W is taken out from the etching processing unit 82 or 83 and loaded into the NH₃ processing unit 84 or 85 by the wafer transfer device 92 to undergo the NH₃ plasma process. That is, in this plasma processing apparatus 100 the etching process and the O₂ plasma process are performed in the etching process unit 82 or 83, and the NH₃ plasma process is performed in situ in the NH₃ plasma processing unit 84 or 85 while maintaining the vacuum state. After that, the wafer W is loaded into one of the load-lock chambers 86 and 87 by the wafer transfer device 92. After returning the load-lock chamber back under the atmospheric pressure, and the wafer W in the load-lock chamber is taken out and loaded into the cleaning chamber 95 by the wafer transfer device 96 in the loading/unloading chamber 88. In the cleaning chamber 95 the wafer W is wet-cleaned with the washing fluid such as water to remove the quality modification film NH₄X. After the cleaning process, the wafer W is taken out therefrom and is loaded into one of the FOUPs F by the wafer transfer device 96. This operation is performed on 1 lot of wafers W, and thus the process for 1 lot is terminated.

In the plasma processing apparatus 100 the structures of the etching processing units 82, 83 and the NH₃ plasma processing units 84, 85 are nearly identical to that shown in FIG. 5 excepting that gas supply systems are different. That is, the etching processing units 82, 83 are equipped with a Cl₂ supply system for an etching gas and an O₂ gas supply system for a cleaning gas, while the NH₃ plasma processing unit is provided with an NH₃ gas supply system for a quality modification gas. Also, similar to the case for the processing unit 2 shown in FIG. 5, the etching process, the O₂ plasma process and the NH₃ plasma process can be performed in the plasma processing apparatus 100.

Hereinafter, the preferred embodiment in accordance with the present invention will be described for a more detailed description, but the present invention is not limited thereto.

### EMBODIMENT 1 AND COMPARATIVE EXAMPLES 1-3

The amount of halogen was measured on the wafer and in the transfer path (in the FOUP) by performing the etching process on the silicon wafer by using corrosive gasses HBr and Cl₂ as the etching gas, and at the same time performing the post-processing by using the O₂ plasma and the NH₃ plasma while varying conditions depending on the test classification. Also, the etching process and the post-process were carried out by using an apparatus whose structure was identical to that shown in FIG. 5.

In the test classification shown in table 1, the result was evaluated for the case where the post-processing was not performed (comparative example 1), the case where only the O₂ plasma process was performed (comparative example 2), the case where only the NH₃ plasma process was performed (comparative example 3), and the case where the NH₃ plasma process was performed after the O₂ plasma process (embodiment 1). As for the plasma processing condition, the etching process was performed for 50 seconds, and the O₂ plasma process and the NH₃ plasma process as the post-process were respectively performed for 5 seconds. Table 1 shows the results.

TABLE 1

| | | Compara- | Compara- | Compara- | |
|---|---|---|---|---|---|
| | | tive exam- | tive exam- | tive exam- | Embodiment |
| | | ple 1 | ple 2 | ple 3 | 1 |
| On | Cl | 14.9 | 17.8 | 4266.7 | 504.7 |
| wafer | (μg/wafer) | | | | |
| | Br | 13.3 | 2.0 | 746.8 | 2.6 |
| | (μg/wafer) | | | | |
| In | Cl | 1.5 | 2.2 | 0.0 | 0.2 |
| FOUP | (ppm/FOUP) | | | | |

As seen from table 1, in both of the comparative example 1 where the post-processing was not performed, and the comparative example 2 where only the O₂ plasma process was performed, the amount of chlorine in the FOUP was very large. It is conjectured that this is resulted from the volatilization of chlorine from the deposits residing on the wafer in the open atmosphere, and there is possibility of the corrosion of the transfer system.

In the comparative example 3 where the NH₃ plasma process was not performed, chlorine was not detected in the FOUP, but it is considered that chlorine is deposited in a form quality-modified into ammonium chloride and ammonium bromide, considering the fact that there were a large amount of chlorine and brome in the wafer. Also, although not shown in table 1, it has been confirmed that a large amount of deposits reside in the chamber.

On the other hand, in the embodiment 1 where the NH₃ plasma process was performed after the O₂ plasma process, only a small amount of chlorine has been detected in the FOUP (0.2 ppm/FOUP), and the fact that the method in accordance with the present invention is effective in preventing the corrosion in the transfer system has been verified. Also, the amount of halogen on the wafer was extremely small when comparing to comparative example 3, and it can be removed by the wet cleaning process. Also, there were little deposits in the chamber and therefore it was effective in preventing the corrosion of the chamber.

### EMBODIMENT 2 AND COMPARATIVE EXAMPLE 4

The etching process was performed on the silicon wafer by using corrosive gasses HBr and Cl₂ as the etching gas, and at the same time the O₂ plasma process and the NH₃ plasma process were performed as a post-process, and furthermore the wet cleaning was performed on the processed silicon wafer (embodiment 2).

The wet cleaning process was performed for 60 seconds by DHF cleaning process by using 5% hydrogen fluoride (HF+H₂O) as a liquid chemical. Also, a DHF cleaning process was performed under the same condition as above for comparison, on the case where only the O₂ process was performed as a post-process (comparative example 4).

For the etching process and the post-process the apparatus whose configuration was identical to that shown in FIG. 5 was employed. As for the plasma processing timing, the etching process was performed for 50 seconds, and each of the O₂ plasma process and the NH₃ plasma process was performed as a post-process for 5 seconds. Also, in the comparative example 4 where only the O₂ plasma etching was performed as a post-process, it was performed for total 10 seconds divided into two 5 seconds intervals.

The amount of halogen on the silicon wafer was measured before and after the wet cleaning process. The measurement of the amount of halogen on the silicon wafer was conducted by immersing the silicon wafer in water of 100 mL to elute the halogen, and then analyzing an effluent by means of the ion-chromatography.

TABLE 2

| | Before Cleaning | | After Cleaning | |
|---|---|---|---|---|
| | Comparative | | Comparative | |
| | example 4: | Embodiment 2: | example 4: | Embodiment 2: |
| | O₂ plasma | O₂ plasma + | O₂ plasma | O₂ plasma + |
| | only | NH₃ plasma | only | NH₃ plasma |
| Cl | 18.3 | 182.2 | 0.10 | 0.07 |
| (μg/wafer) | | | | |
| Br | 2.9 | 18.3 | 0.06 | 0.02 |
| (μg/wafer) | | | | |

As shown in table 2, in the embodiment 2 where the O₂ plasma process and the NH₃ plasma process were performed as a post-process, there were large amounts of both chlorine and brome on the silicon wafer before the wet cleaning process. It is conjectured that the halogen is contained in the qualify modification material. However, respective amounts of both the chlorine and brome were considerably decreased by the wet cleaning to the level in comparative example 4 where only the O₂ plasma process was performed. From this result, it is confirmed that the halogen-containing quality modification material which is formed on the silicon wafer due to the NH₃ plasma process could be easily removed by the wet cleaning.

Although the embodiments in accordance with the present invention have been described, it is not limited thereto and there can be a variety of modifications. For example, although the plasma etching process has been exemplified as the first plasma process and the process using corrosive gas in the above embodiments, but it is not limited thereto and any process can be employed as long as the process uses corrosive gas such as halogen gas.

Also, although the parallel plate type etching apparatus for etching by applying high frequency power onto the upper and the lower electrode has been exemplified in the above embodiments, but it is not restricted thereto and an apparatus of applying high frequency power onto either only upper or lower electrode can be employed, and also magnetron RIE plasma etching apparatus using permanent magnets can be employed. Also, it is not limited to capacitively coupled plasma etching apparatus and it is possible to use other plasma etching apparatuses such as inductively coupled plasma etching apparatus as well.

By the plasma processing and post-processing method in accordance with the present invention, the corrosion due to halogen can be prevented not only in the process chamber but also in the transfer system.

What is claimed is:

1. A plasma processing method for performing a plasma process on an object to be processed in a chamber, comprising:
a first plasma process for processing the object to be processed by a first plasma that is generated by plasmarizing a gas containing at least a halogen element;
a second plasma process for processing the chamber and the object to be processed by supplying an oxygen-containing gas into the chamber to generate a second plasma after the first plasma process; and
a third plasma process for processing the object to be processed after the second plasma process by a third plasma that is generated by plasmarizing a gas containing at least nitrogen and hydrogen.

2. The plasma processing method of claim 1, wherein the first to the third plasma process are performed in the same chamber.

3. The plasma processing method of claim 1, wherein the first and the second plasma process are performed in the same chamber while the third plasma process is performed in a separate chamber.

4. The plasma processing method of claim 1, wherein the halogen element is chlorine or brome, and the gas containing at least nitrogen and hydrogen is an ammonia gas or a mixed gas of nitrogen and hydrogen gas.

5. The plasma processing method of claim 4, wherein silicon halide that is attached to the object to be processed is changed to ammonium halide in the third plasma process.

6. The plasma processing method of claim 5, further comprising a cleaning process for wet-cleaning the object to be processed after the third plasma process.

7. The plasma processing method of claim 1, wherein the first plasma process is a plasma etching process on a silicon substrate.

8. A post-processing method, performed after a process using a corrosive gas being performed on an object to be processed in a chamber, comprising:
O₂ plasma process for processing the chamber and the object to be processed by supplying an oxygen-containing gas to the chamber to generate O₂ plasma; and
NH₃ plasma process for processing the object to be processed after the O₂ plasma process by an NH₃ plasma generated by plasmarizing a gas containing at least nitrogen and hydrogen.

9. The post-processing method of claim 8, wherein the process using a corrosive gas, the O₂ plasma process and the NH₃ plasma process are performed in the same chamber.

10. The post-processing method of claim 8, wherein the O₂ plasma process and the NH₃ plasma process are respectively performed in different chambers.

11. The post-processing method of claim 8, wherein the corrosive gas includes at least a halogen element, and the gas containing at least nitrogen and hydrogen is an ammonia gas or a mixed gas of nitrogen and hydrogen gas.

12. The post-processing method of claim 11, wherein the silicon halide that is attached to the object to be processed in the NH₃ plasma process, is changed to ammonium halide.

13. The post-processing method of claim 12, further comprising a cleaning process for wet-cleaning the object to be processed after the NH₃ plasma process.

14. The post-processing method of claim 8, wherein the process using a corrosive gas is an etching process on a silicon substrate.
